(19) United States
(12) Patent Application Publication
(10) Pub. No.: US 2011/0219597 A1
(43) Pub. Date: Sep. 15, 2011

(54) Brake Drum Removal Device

(76) Inventor: Timothy MILLER, Troutman, NC (US)

(21) Appl. No.: 13/047,336

(22) Filed: Mar. 14, 2011

Related U.S. Application Data
(60) Provisional application No. 61/313,797, filed on Mar. 14, 2010.

(51) Int. Cl. B25B 27/02; B23P 11/00

(52) U.S. Cl. 29/426.5; 29/266

(57) ABSTRACT

A brake drum removal device providing the user with a method of disengaging a brake drum from the drum assembly of a car. The present invention provides users with a device and method to remove the brake drum in a timely manner without the need to strike the drum with a hammer. The present invention makes use of a drum disc with a plurality of drum arms that are able to latch onto a brake drum. The user is able to use a rotary tool to pull the brake drum off of the drum assembly.

The current application claims a priority to the U.S. Provisional Patent application Ser. No. 61/313,797 filed on Mar. 14, 2010.

### FIELD OF THE INVENTION

The present invention relates generally to device used for removing the brake drum. More specifically, the present invention allows the user to easily pull the brake drum off of the drum assembly.

### BACKGROUND OF THE INVENTION

It is necessary for an individual to perform routine maintenance on their vehicle to ensure it is operating safely and properly. Brake pads are one of the vehicle's components that need to be changed as often as necessary. It can be difficult for the vehicle owner or brake specialist to access the brake pads because they must first remove the brake drum. Currently, the user must pound on the brake drum with a hammer to loosen it from the rear wheel assembly. This task can be loud and bothersome for the user as well as for any other individual in earshot. This method can also be time consuming and frustrating for the user. Users need a more effective tool for removing brake drums. The present invention is a specialized tool designed to help the user remove a brake drum in a timelier manner. This unique item is used in conjunction with a lug wrench or an air wrench to pop the brake drum off a rear wheel assembly for accessing the brake pads. This stainless steel tool has an innovative design that includes a hub with four slightly curved arms for achieving a secure grip around the brake drum. The user then simply inserts a wrench into the center of the hub and applies pressure in a clockwise direction until the drum releases. This tool is ideal for use by anyone that performs maintenance on a vehicle.

### BRIEF DESCRIPTION OF THE DRAWINGS

FIG. 1 is a perspective view of the present invention.

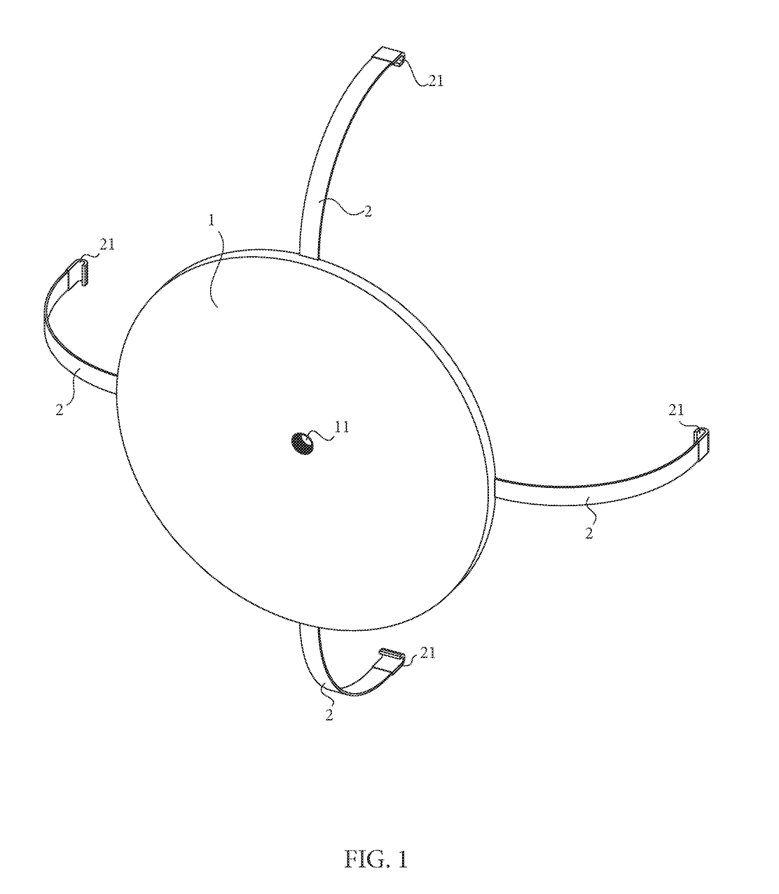

FIG. 2 is a perspective view of the present invention with a brake drum and rotary tool.

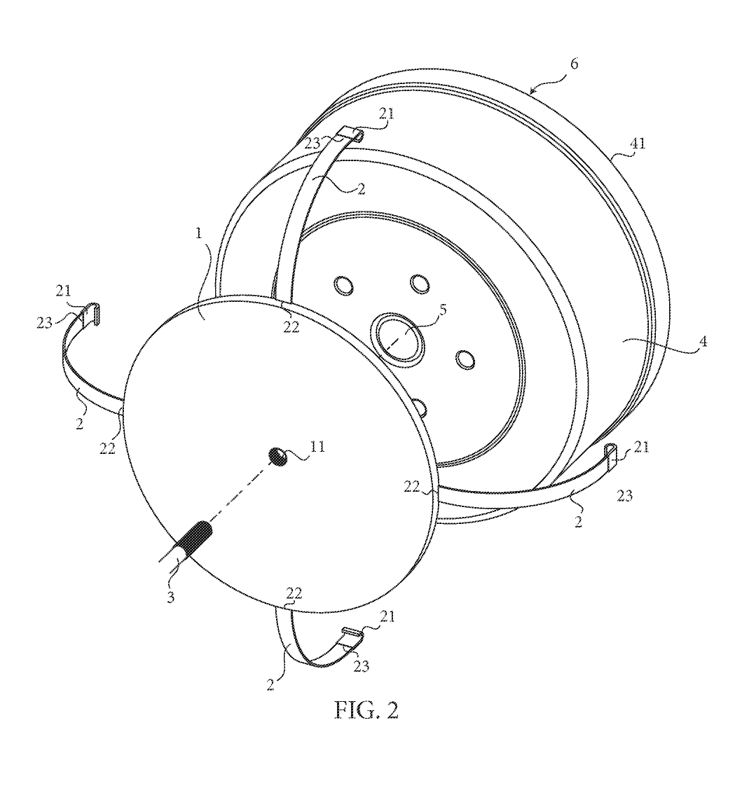

### DETAIL DESCRIPTIONS OF THE INVENTION

All illustrations of the drawings are for the purpose of describing selected versions of the present invention and are not intended to limit the scope of the present invention.

The present invention is a specialized brake drum removal device designed to help a user remove a brake drum 4 in a timelier manner. The present invention comprises of a drum disc 1 and a plurality of drum arms 2. The drum disc 1 comprises of a threaded hole 11. The plurality of drum arms 2 comprises edge clips 21. The threaded hole 11 is a hole traversing through the drum disc 1. The threaded hole 11 is a circular hole centered and positioned in concentric relationship with the drum disc 1. The plurality of drum arms 2 is flexible straps having first ends 22 and second ends 23. The plurality of drum arms 2 is connected to the drum disc 1 by the first end 22. The edge clips 21 are connected to the second end 23 of the plurality of drum arms 2. Each of the plurality of drum arms 2 is circumferentially connected to the drum disc 1 while being distributed in an even fashion. The plurality of drum arms 2 is the portion of the present invention that will physically connect and pull the brake drum 4 off of the drum assembly 5. For this reason, the plurality of drum arms 2 is distributed about the circumference of the drum disc 1 to evenly distribute the pulling force of the brake drum 4. The edge clips 21 is hook shaped to be secured onto the edge of the brake drum 4.

To use the present invention to disengage a brake drum 4, the user requires a threaded rotary tool 3. The threaded rotary tool 3 can be any rotary tool including air guns, lug wrench, electric torque wrench, or any other tools suitable for threading into a threaded hole 11. The brake drum removal device is first secured to the brake drum 4. The brake drum removal device is secured to the brake drum 4 by aligning the drum disc 1 to the brake drum 4. The plurality of drum arms 2 is extended towards the rear edge 41 of the brake drum 4. The edge clips 21 of each of the plurality of drum arms 2 are secured to the rear edge 41 of the brake drum 4. The brake drum removal device is then firmly secured onto the brake drum 4 with the threaded hole 11 aligned to the rear axle shaft 6 of the drum assembly 5. With the brake drum 4 removal device secured onto the brake drum 4, the user is able to use the threaded rotary tool 3 to disengage the brake drum 4 from the rear axle shaft 6 and the drum assembly 5. The threaded rotary tool 3 is inserted and threaded through the threaded hole 11, allowing the tip of the threaded rotary tool 3 to anchor the rear axle shaft 6. As a result, with the threaded rotary tool 3 continuing to be threaded through the threaded hole 11, the rotary tool will continually push off of the rear axle shaft 6 while pulling on the brake drum 4. Once enough force is applied to the brake drum 4, the brake drum removal device will disengage the brake drum 4 from the rear axle shaft 6 and the drum assembly 5 while retaining the brake drum 4. This method of removing the brake drum 4 prevents the need for swinging a hammer and reducing potential injuries that can result from such an action. Additionally, without having to hammer the brake drum 4, the user remove the risk of striking the brake drum 4 in an awkward positioned that can potentially permanently damage the brake drum 4.

Although the invention has been explained in relation to its preferred embodiment, it is to be understood that many other possible modifications and variations can be made without departing from the spirit and scope of the invention as hereinafter claimed.

What is claimed is:

1. A Brake Drum Removal Device comprises,
a drum disc;
a plurality of drum arms;
the drum disc comprises a threaded hole;
the plurality of drum arms comprises a edge clip;
the drum disc being circularly shaped consistent to a brake drum; and
the threaded hole being a hole traversing through the drum disc.

2. The Brake Drum Removal Device as claimed in claim 1 comprises,
the plurality of drum arms being flexible straps having first ends and second ends;
the plurality of drum arms being connected to the drum disc by the first ends; and
the edge clip being connected to the second ends.

3. The Brake Drum Removal Device as claimed in claim 2 comprises,
the plurality of drum arms being circumferentially connected and distributed on the drum disc in an even fashion; and
the edge clip being hook shaped.

4. The Brake Drum Removal Device as claimed in claim 1 comprises,
the threaded hole being center positioned in concentric relationship to the drum disc.

5. A Brake Drum Removal Device comprises,
a drum disc;
a plurality of drum arms;
the drum disc comprises a threaded hole;
the plurality of drum arms comprises a edge clip;
the drum disc being circularly shaped consistent to a brake drum;
the threaded hole being a hole traversing through the drum disc;
the threaded hole being center positioned in concentric relationship to the drum disc;
the plurality of drum arms being flexible straps having first ends and second ends;
the plurality of drum arms being connected to the drum disc by the first ends;
the edge clip being connected to the second ends;
the plurality of drum arms being circumferentially distributed on the drum disc in an even fashion; and
the edge clip being hook shaped.

6. A method of using the Brake Drum Removal Device to remove a brake drum comprises,
providing a brake drum;
providing a brake drum removal device having a drum disc and a plurality of drum arms, wherein the drum disc has a threaded hole and the plurality of drum arms have edge clips;
providing a threaded rotary tool;
securing the brake drum removal device to the brake drum; and
threading the threaded rotary tool into the threaded hole in clockwise motion to disengage the brake drum.

7. The method as claimed in claim 6 comprises,
wherein the threaded rotary tool is a rotary tool selected from the group consisting of an air gun, a lug wrench, or an electric torque wrench.

8. The method as claimed in claim 6 comprises,
wherein the brake drum removal device is secured to the brake drum by aligning the drum disc to the brake drum, extending the plurality of drum arms towards the rear edge of the brake drum, securing the edge clips to the rear edge of the brake drum.

9. The method as claimed in claim 6 comprises,
wherein the brake drum is disengaged from rear axle shaft and drum assembly by the threaded rotary tool being threaded through the threaded hole and anchoring the rear axle shaft while pulling the brake drum.
